(19) United States
(12) Patent Application Publication
(10) Pub. No.: US 2002/0062254 A1
(43) Pub. Date: May 23, 2002

(54) METHODS AND APPARATUS FOR CUSTOMER SPECIFIC PRICE VERIFICATION

(76) Inventor: MICHAEL JAMES MATSKO, LAWRENCEVILLE, GA (US)

Correspondence Address: PAUL W MARTIN, NCR CORPORATION, LAW DEPARTMENT, 101 W SCHANTZ AVENUE, DAYTON, OH, 45479

(21) Appl. No.: 09/459,936

(22) Filed: Dec. 13, 1999

(51) Int. Cl. G06F 17/60

(52) U.S. Cl. 705/20; 705/14

(57) ABSTRACT

A price verifier employing customer-specific information to allow for the display of prices adjusted for membership in frequent-shopper programs or other programs which offer prices adjusted according to the identity of a customer. A customer enters a product identification, for example, by scanning a barcode label. The customer is then prompted to enter customer identification information, which may be done, for example, by scanning a frequent shopper card. The price verifier looks up the product price in a price lookup table and then looks up price adjustments based on the customer identification information. The price verifier then displays the adjusted price. The price verifier may also advise the customer of promotions associated with the product being verified, or related products, and may also inform the customer of promotions associated with promotional or frequent shopper programs of which the customer is a member.

### FIELD OF THE INVENTION

The present invention relates generally to a retail price verifier. More particularly, the invention relates to a price verifier which employs customer-specific information for accurate verification of prices which may vary depending on customer-specific information such as frequent shopper program membership, purchase volume, purchase history, special incentives directed to a specific customer, and the like.

### BACKGROUND OF THE INVENTION

Many retailers do not place individual prices on each product in a store. Instead, prices are displayed at a convenient location such as on a shelf tag located on a rail along a shelf upon which the products are located. Prices are stored in a price lookup table (PLU) in a central registry for lookup when a product is presented for purchase. When a product is presented for purchase at a point of sale (POS) terminal, a product identification is entered into the terminal, for example through scanning a Universal Product Code (UPC) label or other barcode label. The price of the product is then retrieved from the price lookup table and the price of the product is typically displayed as the product is entered into the transaction.

However, if the product does not carry any human-readable price information, the customer must depend on the accuracy of a shelf label or other pricing information in order to know the price of the product. If the pricing information is missing from the shelf, it is not easy for the customer to find out the price of a product which he or she may want to purchase. Typically, a customer's only recourse is to wait in line at a checkout station and ask the checkout clerk to scan the product and report the price. This approach is inconvenient to customers, and many customers will simply choose not to purchase a product rather than go to this trouble. An incorrect shelf price leads to substantial customer dissatisfaction and increases the transaction time.

In order to provide customers with more current and reliable information about pricing, many retailers have installed electronic price displays in convenient locations, to enable customers to scan products to determine their prices, without the need to stand in line at a checkout or ask a clerk for assistance.

There exist a number of limitations with respect to presently existing price displays. One such problem becomes particularly evident in the presence of customer loyalty and incentive programs and other uses of customer-specific information which affect the price to be paid by a customer. In addition to membership or nonmembership in an incentive program, extensive additional information may be employed, such as purchase volume, incentives earned, history of dealings with the retailer, special incentives or prices offered to the specific customer, or the like. This information provides the opportunity for targeted marketing, in which the retailer may deal with each customer as an individual or member of a small and well-defined group, rather than dealing with customers exclusively as members of large groups. In the presence of such programs, and especially in cases in which detailed information is used, prices will vary from customer to customer. If a price display does not take into account customer-specific information relating to a particular customer, but simply scans the product and displays the price which prevails in the absence of such information, a likelihood exists that an incorrect price will be displayed.

Customer loyalty and incentive programs typically reward the customer with a lower price, so that if a price display does not take this information into account when displaying the price, the price displayed may be higher than the price which actually prevails. In that case, the customer will believe that the price is higher than it actually is, and may forego the purchase. On the other hand, if the price displayed is lower than the actual price prevailing at the point of sale, the customer will experience considerable dissatisfaction upon finding that the price of the product is higher than expected.

Presently existing price verifiers are known which display prices based on a simple criterion such as a customer's membership or nonmembership in an incentive program such as a frequent shopper club. However, the price verifiers of the prior art do not take detailed customer-specific information into account and do not display a price which is truly specific to the individual customer.

There exists, therefore, a need in the art for a price verifier which is capable of receiving customer-specific information for use in determining a correct price for a product and which uses the information to compute and display a price applicable to a specific customer.

### SUMMARY OF THE INVENTION

A price verifier according to one aspect of the present invention comprises a product identification interface, a customer input interface, a price lookup database, a processor and a display. When a customer wishes to check the price of a product, the customer enters the product identification using the product identification interface. The product identification interface may be, for example, a scanner operative to read a barcode label on the product. After entering the product identification, the customer enters customer-specific identification information using the customer interface, which is then used as an index to retrieve information applicable to that customer. Alternatively, the customer may enter the customer information directly. The processor then uses the customer-specific information to compute a price applicable to the customer and the price verifier displays the price in a convenient manner.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a price display according to the present invention;

FIG. 2 illustrates a method of price verification using customer-specific information according to the present invention;

FIG. 3 is a perspective view of a price verifier according to the present invention;

FIG. 4 is a front perspective view of a wall mounted portion of a price verifier according to the present invention;

FIG. 5 is an exploded view of the wall mounted portion of a price verifier according to the present invention;

FIG. 6 illustrates a price verifier according to another aspect of the present invention; and

FIG. 7 illustrates a price verifier according to a further aspect of the present invention.

### DETAILED DESCRIPTION

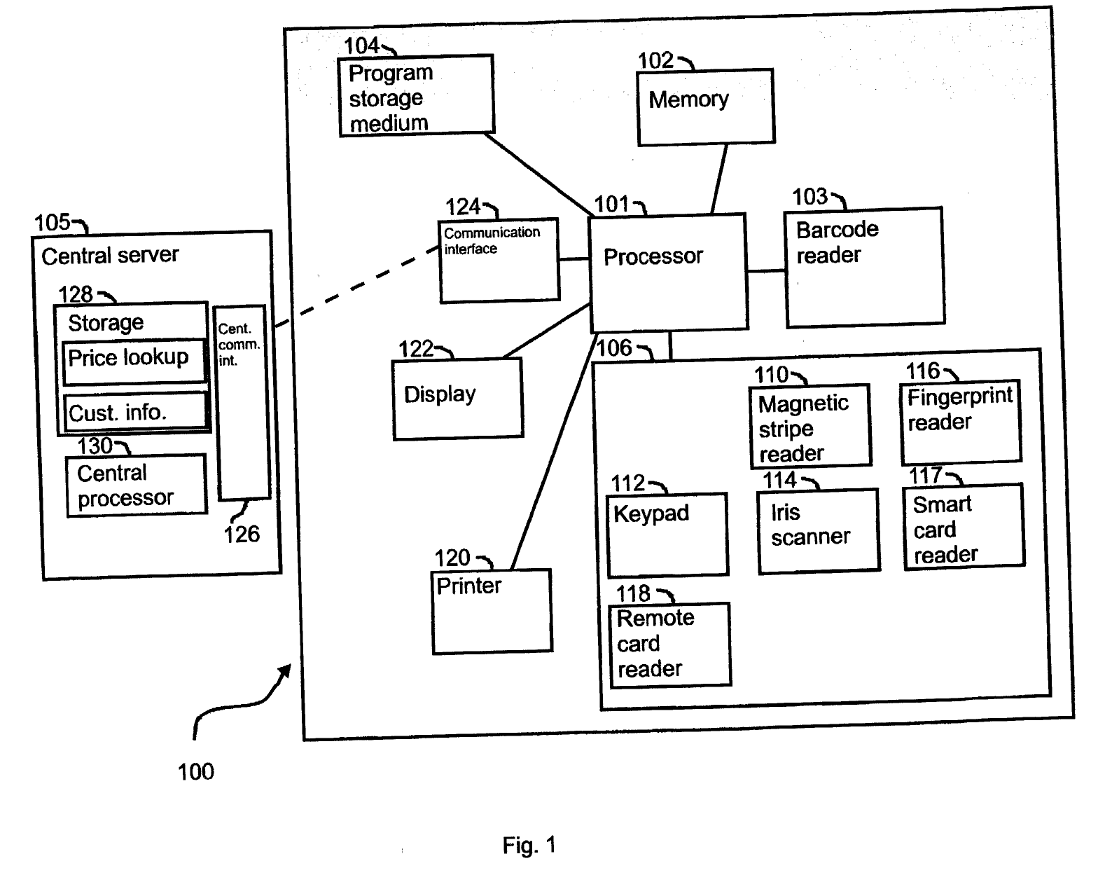

FIG. 1 illustrates a price verifier 100 according to one aspect of the present invention. The price verifier 100 is suitably used in parallel with a plurality of similar price verifiers operated at a single retail location. The price verifier 100 includes a processor 101, which has access to memory 102 for storing data used during operation of the price verifier 100. The processor 101 also communicates with a product identification interface which is preferably a barcode reader 103, capable of reading Universal Product Code labels and other barcoded labels. The processor also has access to a program storage medium 104, which stores basic commands and data which the processor 101 reads when power is initially applied to the price verifier 100, or when the processor 101 receives a command to restart. The basic commands within the program storage medium 104 may be changed by reprogramming the price verifier 100, either using programming bar code labels or by sending programming commands from a central server 105. The processor 101 also communicates with a customer information interface 106, which is capable of receiving information from a variety of sources which may include the barcode reader 103, a magnetic stripe reader 110 and a keypad 112, as well as devices for collecting biometric information such as an iris scanner 114 or a fingerprint reader 116. The customer information interface may also include a smart card reader 117 for reading customer information from a smart card. Because of the relatively large information storage capacity of a smart card, the use of a smart card reader allows the price verifier 100 to read detailed customer information directly from a smart card without a need to look up the information in the central server 105. As a further alternative, the customer interface 106 may include a remote device reader 118 for reading a remotely readable device such as a noncontact card, allowing detection of an identification device carried by the customer without a need for the customer to physically place the device in a reader. The price verifier 100 may use any one or any combination of the above-mentioned devices or other devices suitable for providing information to a data processing device. The price verifier 100 also includes customer communication devices such as a printer 120 for providing price information in printed form or for printing coupons for a customer or providing promotional or other information, and a display screen 122 for displaying price information and other information or instructions to be communicated to the customer. The display screen 122 may suitably be a vacuum fluorescent display, liquid crystal display, or any of a number of other commonly available display types.

The price verifier 100 also includes a communication interface 124, which provides communication between the processor 101 and the central server 105. The central server 105 serves the price verifier 100 as well as similar price verifiers deployed at the retail location. The central server 105 includes a central communication interface 126 which allows the central server 105 to transmit and receive information from the price verifier 100 and similar price verifiers. The central server 105 also includes storage 128, which may suitably contain a price lookup table which includes prices for all products at the retail location, each price being associated with a corresponding product identification. The storage 128 also includes a table of customer information which may be used as a basis for adjustment of prices. The customer information may include membership in one or more incentive programs such as frequent shopper club memberships, student discount programs, senior discount programs, eligibility for discounts or promotions, purchase volume, purchase history, special incentives or prices offered to the customer, or other customer-specific information which needs to be taken into account in determining the price of a product. The storage 128 may also include a list of adjusted prices, or alternatively may include preprogrammed adjustments or algorithms to be used to adjust prices in accordance with customer information. Adjusted prices would be computed by using the customer information as inputs to the preprogrammed algorithms. Alternatively, the price verifier 100 may store algorithms to be used in conjunction with the customer information in order to make adjustments to a base price received from the central server 105. For example, an adjustment may be made to account for membership in both a frequent-shopper program and a senior discount program. The adjustment to be made would be greater than for membership in either program alone. Such an adjustment might advantageously be made using a formula which combined a discount factor applicable to each program. This formula could be stored by the price-verifier 100 and employed to compute the customer-specific price applicable to such a situation.

When a customer approaches the price verifier 100, he or she may scan the product using the barcode reader 103. The barcode reader 103 provides the UPC information to the processor 101. The processor 101 is alerted that a product has been scanned, and causes the display 122 to provide a prompt to the customer to provide customer information.

If there is no customer-specific information to provide, the customer makes an entry using the keypad 112 and the processor 101 looks up the price in the price lookup table in the central database 105 and commands the display screen 122 to display the price. If the customer makes no keypad entry and does not otherwise provide customer information, the price verifier simply waits for a predetermined delay time and then displays the price.

If the customer has customer-specific information to provide, the customer provides the information using the customer information interface 106. For example, the customer may scan a card using the barcode reader 103, pass a magnetic card through the magnetic stripe reader 110 or make a keypad entry, as appropriate. For example, the customer may scan a frequent shopper card using the barcode reader 103 or may enter a frequent shopper identification number or code using the keypad 112. Alternatively, the customer may place his or her fingers on the fingerprint reader 116 or look into the iris scanner 114 to allow the price verifier 100 to read biometric information identifying the customer. Alternatively, the remote card reader 118 may read a remotely readable card carried on the customer's person and capable of being read from a distance, thereby relieving the customer of the need to manually conduct the identification procedure. As a further alternative, the customer may use a smart card with the smart card reader 117, which allows the customer information to be read directly from the card without a need to access the central database 105. The processor 101 then uses the customer information which has been provided and makes appropriate adjustments to the product price. This adjustment may be done by looking up alternative prices in the price lookup table, or by applying a discount according to a formula which depends on the customer information provided. The processor 101 then commands the display screen 122 to display the price.

In addition to reporting the price of a product to the customer, the price verifier 100 may also retrieve information about promotions and specials from the central database 105. This information may be retrieved based on the information relating to the product presented for verification. For example, if a customer verifies the price for a meat product, the verifier 100 may present promotional information related to other meat products or other products which may be linked with that product, for example, products needed for a barbecue. The price verifier 100 may also present promotional information related to the customer-specific information, for example, special discounts available to frequent shopper club members. The verifier 100 may suitably use the printer 120 to print coupons related to these promotions.

Moreover, the price verifier 100 may also provide inventory information in cases where a customer does not take a product from the shelf to a checkout for purchase, but rather chooses a tag associated with the shelf display of the product and takes the tag to the checkout to allow a retail employee to retrieve of the product from storage and perform the sale. In this case, the product tag may include a barcode containing product identification. The customer can scan the barcode at the price verifier 100 and provide customer identification information, and the price verifier 100 will then retrieve the price of the product and compute a customer-specific price, and also retrieve from the central database 105 the amount of inventory remaining. The price verifier will then display this information using the display 122 or print the information using the printer 120. In addition to being informed of the customer-specific price for the product, the customer can also be informed if the desired product is out of stock and avoid the inconvenience and annoyance of making a pointless trip to the checkout.

It is also possible to employ a central processor 130 in the central server 105. In this case, when a price verifier such as the price verifier 100 sends product information and customer identification information to the central server 105, the central processor 130 looks up the base price information and customer information and uses the customer information to compute an adjusted price. The central server 105 then transmits the adjusted price to the price verifier 100. This implementation centralizes the price adjustment computation and reduces the processing power needed for each of the price verifiers such as the price verifier 100.

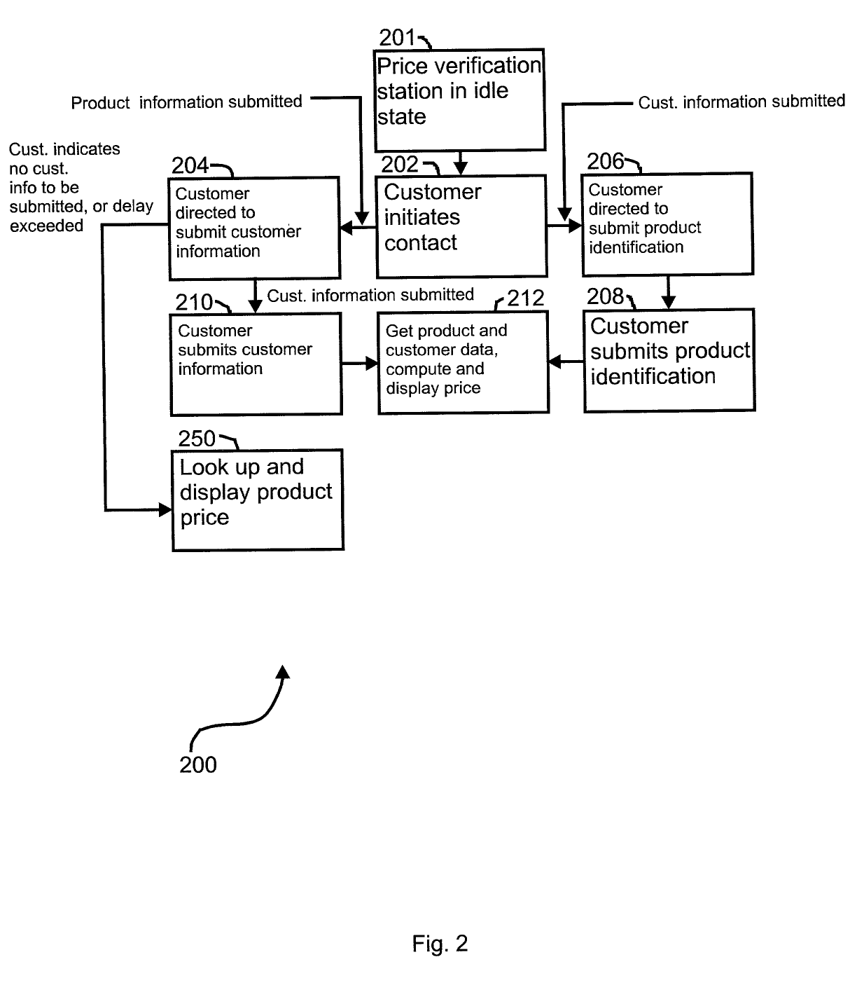

FIG. 2 illustrates the steps of a method 200 of customer-specific price verification according to the present invention. At step 201, a price verifier remains in an idle state awaiting customer input. In this idle state, the display may be blank or a promotional or teaser display may be displayed. At step 202, a customer approaches a price verifier, which may be similar to the price verifier 100 of FIG. 1. At step 204, the customer initiates contact with the price verifier, either by submitting customer identification information such as a customer identification card or identification number, or by submitting product identification information, such as by scanning a barcode label on a product. If customer information has been submitted, the process proceeds to step 206 and the customer is directed to submit product identification information. At step 208, the customer submits product identification by scanning a barcode associated with the product or by other suitable means. After product identification information has been submitted, the process then proceeds to step 212.

If product identification information was submitted at step 204, the customer is directed to submit customer identification or to indicate that no customer identification will be submitted. If the customer indicates that no customer identification information will be submitted, or if a predetermined period of waiting for customer input is exceeded, the process proceeds to step 250. Otherwise the customer submits customer identification information at step 210 and the process proceeds to step 212.

At step 212, product information is used to retrieve price data for the product. Customer information and product identification information are used to retrieve data or formulas used to adjust the price or not, as appropriate to the customer. The price is computed using the retrieved data and formulas and displayed to the customer. The process then returns to step 201.

At step 250, the product information is used to retrieve price data for the product and the price of the product is displayed.

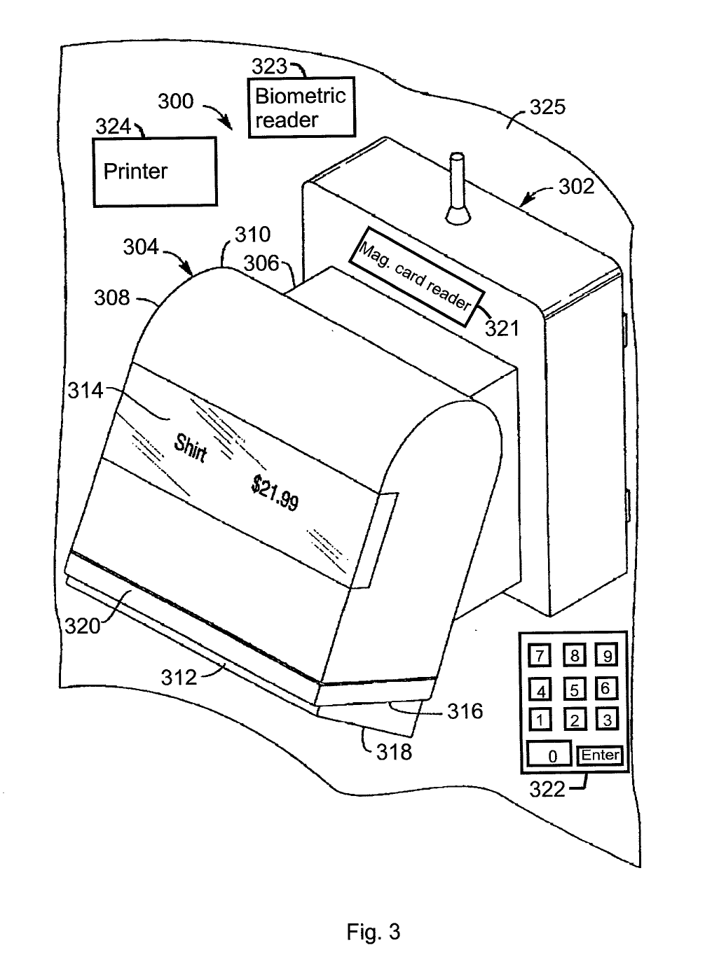

FIG. 3 illustrates details of a suitable configuration of a price verifier 300 according to the present invention. The price verifier 300 may suitably be assembled as a wall-mounted base section 302 together with a snap-on cover section 304. The snap-on cover section 304 includes a generally rectangular mounting assembly 306, which abuts the wall-mounted base section 302. The snap-on cover section 304 also includes a scanner and display assembly 308, which is also generally rectangular in shape but has a curved rear surface 310. The scanner and display assembly 308 contains a bar code reader 312 and display 314, and is oriented at a downward angle to the base section 306 for easy customer viewing of a display 314 on a surface 316 and for easy scanning through a window 318 on a surface 320. The surface 320 is preferably generally perpendicular to the surface 318. The price verifier 300 also includes the additional elements of a customer information interface, including a magnetic card reader 321, a keypad 322 and a biometric reader 323, and also preferably includes a printer 324.

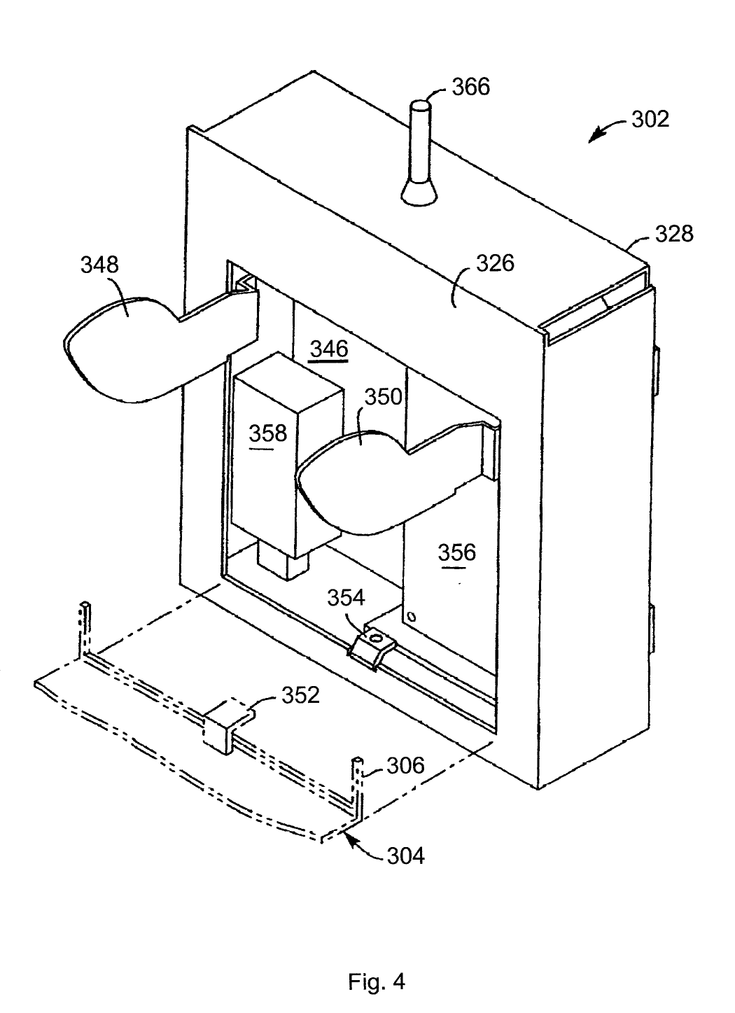

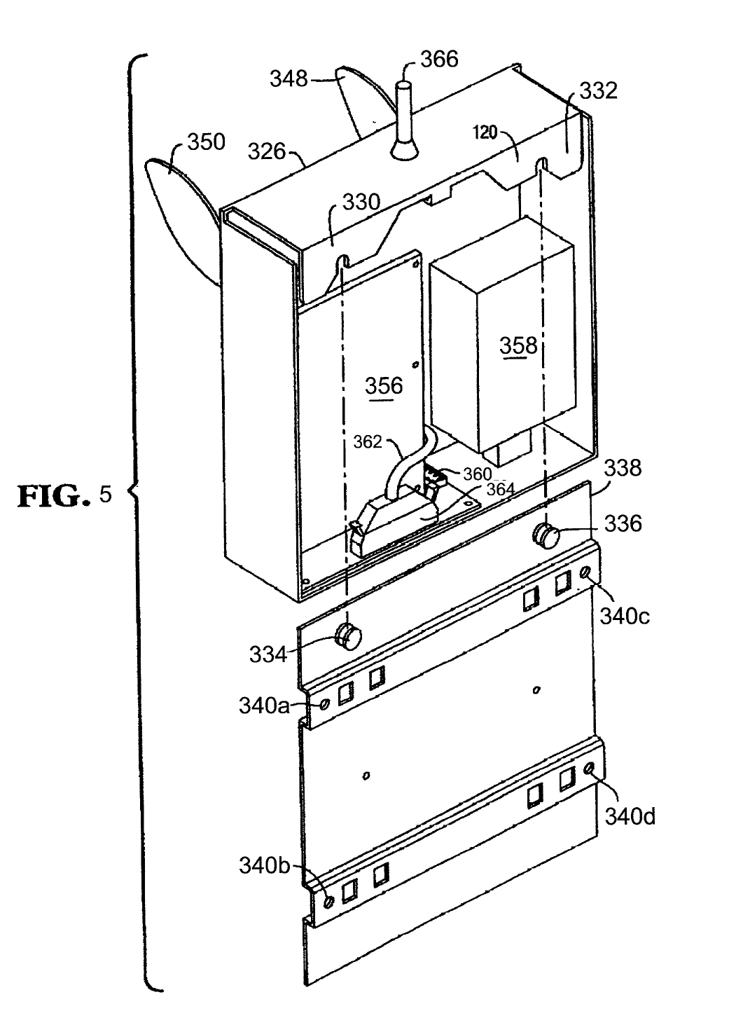

Turning now to FIGS. 4 and 5, the wall-mounted base section 302 is shown in further detail in these figures. The wall-mounted base section 302 is generally box-like in shape and has front and rear surfaces 326 and 328. The rear surface 328 includes two mounting flanges 330 and 332 which rest upon studs 334 and 336 on mounting bracket 338 when the base section 302 is installed. The mounting bracket 338 fastens to a wall or other mounting surface using screws or other fasteners through apertures 340 through 344.

The front surface 326 contains an aperture 346 and mounting arms 348 and 350, which are inserted within the generally rectangular mounting assembly 306 of the snap-on cover section 304. The mounting arms 348 and 350 have a shape corresponding to the surface 310 and the mounting assembly 306. The assembly 306 includes a latch 352 which contacts a retainer 354 to secure the cover section 304 to the base section 302. The cover section 304 is installed by first inserting the mounting arms 348 and 350 into the cover section 304 and then pivoting the mounting assembly 306 downwards so that the latch 352 engages the retainer 354.

The base section 302 includes communication circuitry 356 and power control circuitry 358. The communication circuitry 356 is coupled to the control circuitry 360 within the cover section 304 through a cable 362. The cable 362 employs a connector 364.

In FIG. 4, the communication circuitry 356 is shown implemented as a wireless network protocol and includes an antenna 366. This makes the price verifier 300 quicker and easier to install than for wire-based protocol connections, although these protocols are also available to provide retailers with a variety of installation choices. A central server designed to be used with the price verifier 300 may also be configured in a similar fashion.

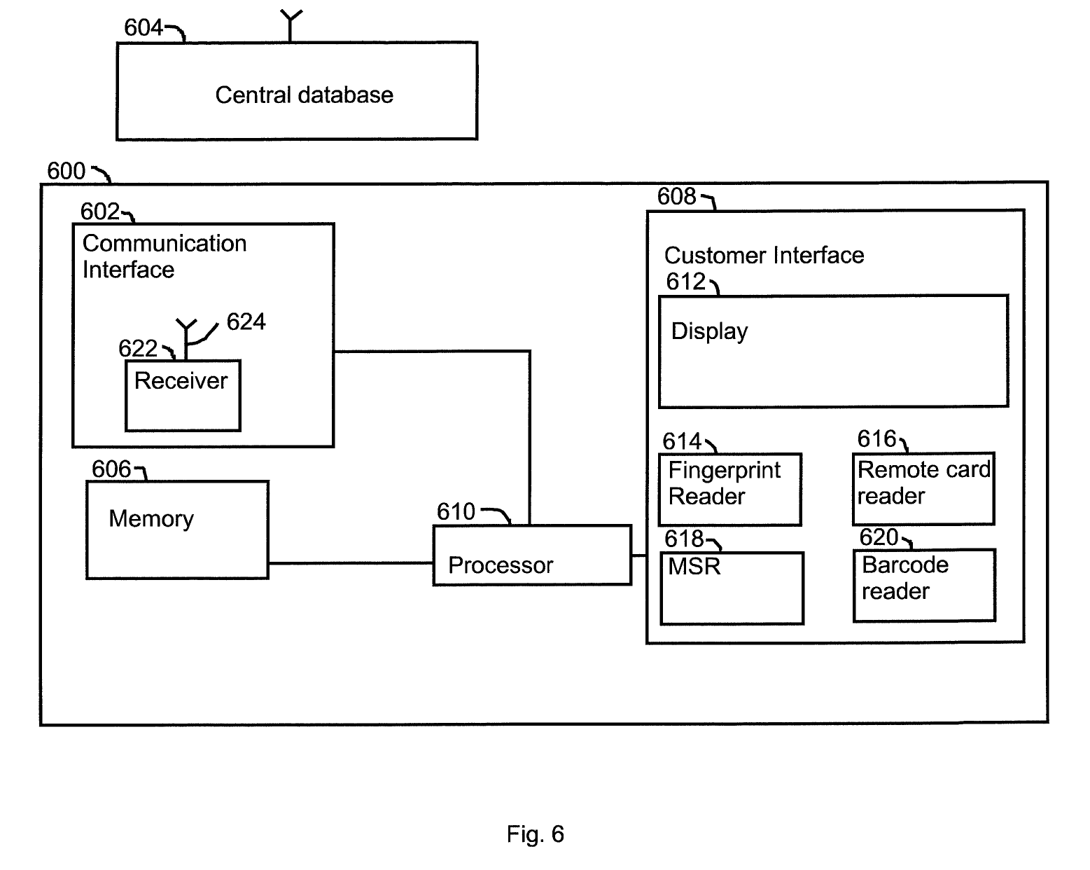

FIG. 6 illustrates a price verifier 600 according to an alternative aspect of the present invention. The price verifier 600 is dedicated to storing and displaying a price for a single product and is therefore suitable for use as an electronic price label. The price verifier 600 includes a communication interface 602 for relaying information to and from a central database 604, memory 606 for storing product identification, pricing and other information received from the central database 604, a customer interface 608 for receiving customer identification information and providing pricing and other information to a customer, and a processor 610 for managing information transfer and controlling the operation of the price verifier 600, and for making price adjustments based on customer information received from the central database 604.

The customer interface 608 includes a display 612 for communicating pricing and other information to a customer, as well as a customer identification reader which is preferably a small and unobtrusive device such as a fingerprint reader 614 or remote card reader 616, but which may also be a magnetic stripe reader 618 or barcode scanner 620. The communication interface includes a receiver 622 and transmit/receive antenna 624 for transferring information between the price verifier 600 and the central database 604.

When the price verifier 600 is installed, and periodically thereafter, the central database 604 transmits product identification information to the price verifier 600. The product identification information is stored in the memory 606. Subsequently, the central database 604 transmits pricing information to the price verifier 600 for the product whose product identification is stored. The pricing information may be retained in the memory 606, or may be retrieved from the central database 604 whenever the price verifier 600 needs to display a price. The pricing information reflects a base price available to the general public, which may be adjusted by the processor 610 based on customer information received from the central database 604.

When a customer initially approaches the price verifier 600, the display 612 displays a predetermined message, such as the base price available to the general public, a message inviting the customer to provide customer identification such as swiping or scanning a card or placing his or her finger on the fingerprint reader 614 or providing other identification, or any other desired message. Alternatively, if the price verifier 600 is equipped with the remote card reader 616 and the customer has on his or her person a remotely readable identification card adapted to use by the price verifier 600, the remote card reader 616 simply reads the card. Once the customer identification is obtained, it is provided to the central database 604, which uses the customer identification to retrieve customer information relating to the customer to whom the customer identification relates, and provides this information to the price verifier 600. The central database 604 also transmits base price information to the price verifier 600, if needed. The processor 610 then uses the customer information to make appropriate adjustments to the base price, and sends the adjusted price to the display 612. It is also possible to send promotional or other messages to the display 612.

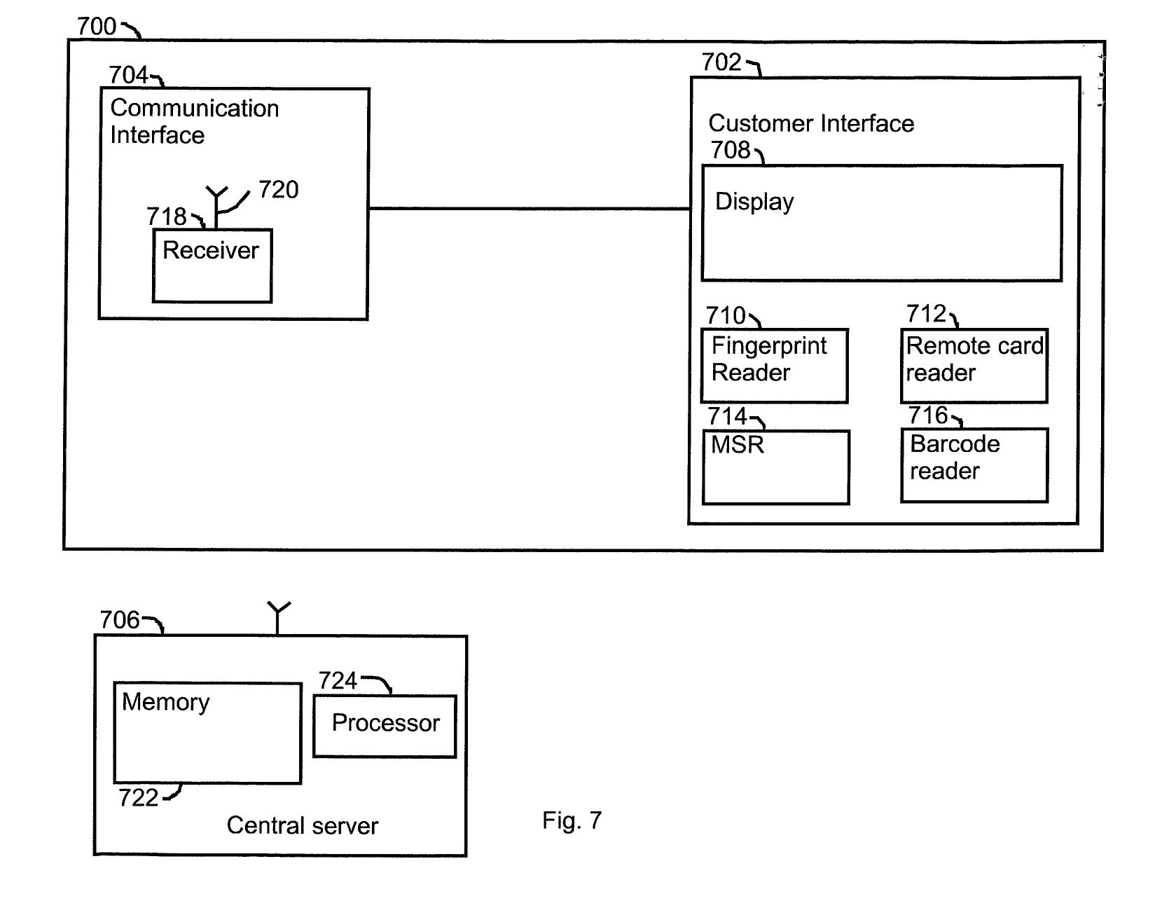

FIG. 7 illustrates a price verifier 700 according to an alternative aspect of the present invention. The price verifier 700 is dedicated to storing and displaying a price for a single product and is therefore suitable for use as an electronic price label. The price verifier 700 is similar to the price verifier 600 of FIG. 6, but includes only a customer interface 702 similar to the customer interface 608 of FIG. 6 and a communication interface 704 for communicating with a central server 706.

The customer interface 702 includes a display 708 for communicating pricing and other information to a customer, as well as a customer identification reader which is preferably a small and unobtrusive device such as a fingerprint reader 710 or remote card reader 712, but which may also be a magnetic stripe reader 714 or barcode scanner 716. The communication interface includes a receiver 718 and transmit/receive antenna 720 for transferring information between the price verifier 700 and the central database 706. The central server 706 includes memory 722 for storing price and product information and other required information, and a processor 724 for performing price calculations and for controlling the operation of the price verifier 700 and the central server 706.

The central server 706 maintains product and price information for each of a plurality of products, as well as address information for each of a plurality of price verifiers such as the price verifier 700. The central server 706 maintains pricing information for display by the price verifier 700 and transmits the pricing information to the price verifier 700 as needed. When a customer provides customer identification information to the price verifier 700, similar to the way in which a customer provides customer identification information to the price verifier 600 of FIG. 6, the price verifier 700 transmits this information to the central server 706. The central server 706 uses the customer identification information to retrieve customer information and compute a customer specific price applicable to the customer. The central server 706 then transmits the customer specific price to the price verifier 700 for display. The central server 706 may also transmit promotional messages similar to those provided by the price verifier 600 of FIG. 6.

While the present invention is disclosed in the context of a presently preferred embodiment, it will be recognized that a wide variety of implementations may be employed by persons of ordinary skill in the art consistent with the above discussion and the claims which follow below.

I claim:

1. A price verifier for use in a retailing operation comprising:
a customer interface to allow a customer to enter product identification information, the customer interface also being operative to allow the customer to enter customer identification information;
a communication interface for retrieving price information from a central server including product price information indexed to the product identification information and for retrieving customer information relating to the customer identified by the customer identification information;
a processor for using the product identification information to retrieve the product price information from the central server and to use customer information from a customer information database to make price adjustments based on the customer information and to compute a price using the price adjustments; and
a customer communication device for communicating to the customer the price computed by the processor.

2. The price verifier of claim 1 wherein the price information retrieved from the central server is a base price and wherein the processor is operative to use the customer information as inputs to preprogrammed algorithms to adjust the base price to compute a customer-specific price.

3. The price verifier of claim 2 wherein the customer interface includes a bar code reader for reading product bar codes and bar codes from customer identification cards.

4. The price verifier of claim 2 wherein the customer interface further includes a keypad for allowing manual entries by a customer.

5. The price verifier of claim 2 wherein the customer interface further includes a smart card reader for reading customer identification and information stored on the smart card.

6. The price verifier of claim 2 wherein the customer interface further includes a remote card reader for reading a noncontact customer identification device carried by the customer.

7. The price verifier of claim 2 wherein the customer interface further includes a biometric reader for collecting and interpreting biometric information relating to the customer.

8. The price verifier of claim 7 wherein the biometric reader includes a fingerprint reader.

9. The price verifier of claim 7 wherein the biometric reader includes an iris scanner.

10. The price verifier of claim 2 wherein the customer interface includes a magnetic stripe reader for reading a magnetically encoded customer identification device.

11. The price verifier of claim 1 wherein the price lookup database stores alternative prices for each of one or more products wherein each of the alternative prices is indexed to customer information and wherein the processor selects one of the alternative prices for a product based on customer information, the customer information being retrieved from the customer information database based on customer identification information entered by the customer.

12. The price verifier of claim 2 wherein the processor selects products related to the product being verified and provides promotional information related to those products.

13. The price verifier of claim 12 wherein the processor is operative to retrieve promotional information relating to the product being verified and communicates to the customer the promotional information relating to that product.

14. The price verifier of claim 2 wherein the processor recognizes product identification information relating to products which are typically retrieved from storage by retail employees upon submission of a tag by a customer and wherein the processor directs the display of inventory information when product identification information relating to such a product is submitted for verification.

15. The price verifier of claim 2 wherein the price verifier includes a price lookup database for storing product price information and a customer information database, and wherein the price lookup database and the customer information database are stored locally within the price verifier.

16. A price verifier for use in a retailing operation comprising:
a customer interface to allow a customer to enter product identification information, the customer interface also being operative to allow the customer to enter customer identification information;
a communication interface for sending the product identification information and the customer identification information to a central server and for receiving from the central server price information reflecting a price applicable to the product identified by the product identification information and available to the customer identified by the customer identification information; and
a customer interface device for communicating the price information to the customer.

17. A central server comprising:
storage for storing product information for a plurality of products and customer information for a plurality of customers, the product information including price information for each product;
a central communication interface for receiving product identification and customer identification information from a price verifier, the communication interface being also operative to transmit price information to the price verifier;
a processor for retrieving product information relating to the product identified by the product identification information and customer information identified by the customer identification information and using the customer information to compute a price applicable to the product identified by the product identification information and available to the customer identified by the customer identification information.

18. The server of claim 17 wherein the price is computed by using the customer information as inputs to preprogrammed algorithms to adjust a base price applicable to the product.

19. A method of price verification, comprising the steps of:
receiving product identification from a customer;
receiving customer identification information from a customer;
retrieving price information using the product identification information;
retrieving customer information using the customer identification information;
using the customer information and the price information to compute an adjusted price based on the customer information; and
providing notification of the adjusted price.

20. The method of claim 19 wherein the step of receiving the product identification from the customer includes receiving barcode information from a universal product code associated with the product.

21. A price verifier for use in a retailing operation comprising:
storage for storing product identification information for a single product;
a customer interface for receiving customer identification information relating to a specific customer;
a communication interface for retrieving from a central database price information for the product represented by the product identification information, the communication interface being further operative to transmit the customer identification information to the central database and retrieve customer information from the central database; and
a processor for using the customer information to adjust the base price to compute a price available to the customer designated by the received customer identification information; and
a display for displaying the price computed by the processor.

22. The price verifier of claim 21 wherein the price information retrieved from the central database is a base price and wherein the processor is operative to use the customer information as inputs to preprogrammed algorithms to adjust the base price to compute a customer-specific price.

23. The price verifier of claim 22 wherein the customer interface includes a fingerprint reader.

24. The price verifier of claim 22 wherein the customer interface includes a remote card reader.

25. A price verifier for use in a retailing operation comprising:
a customer interface for receiving customer identification information relating to a specific customer;
a communication interface for transmitting the customer identification information to a central database and for retrieving from a central server product information, base price information and customer-specific price information for a single product, the adjusted information being computed by the central server by making computations using customer information identified by the customer identification information in order to adjust the base price information to compute the adjusted price information; and
a display for displaying the product information, base price information and adjusted price information received from the central server.

26. The price verifier of claim 25 wherein the customer interface includes a fingerprint reader.

27. The price verifier of claim 25 wherein the customer interface includes a remote card reader.

28. A central server for use in a retailing operation comprising:
storage for storing product identification and base price information for each of a plurality of products, as well as customer identification information for each of a plurality of customers, the customer identification information for each customer being associated with customer information for that customer;
a communication interface for receiving customer identification information from one or more of a plurality of price verifiers, the communication interface being further operative to transmit to each price verifier base price information, product information and adjusted price information applicable to the price verifier;
a processor for making computations using the customer information received from each price verifier in order to adjust the base price applicable to the price verifier from which the customer identification was received in order to compute an adjusted price available to the customer designated by the received customer identification information.

29. The central server of claim 28 wherein the processor is operative to use the customer information as inputs to preprogrammed algorithms to adjust the base price to compute a customer-specific price.
